(19) United States
(12) Patent Application Publication
(10) Pub. No.: US 2025/0085550 A1
(43) Pub. Date: Mar. 13, 2025

(54) OPTICAL SYSTEM AND DISPLAY DEVICE

(71) Applicants: Yoshifumi SUDOH, Kanagawa (JP); Takemasa TSUTSUI, Kanagawa (JP)

(72) Inventors: Yoshifumi SUDOH, Kanagawa (JP); Takemasa TSUTSUI, Kanagawa (JP)

(21) Appl. No.: 18/823,819

(22) Filed: Sep. 4, 2024

(30) Foreign Application Priority Data
Sep. 11, 2023 (JP) 2023-146631

(51) Int. Cl. G02B 27/01; F21V 8/00; G02B 13/12; G02B 27/30

(52) U.S. Cl. CPC G02B 27/0172; G02B 6/003; G02B 6/0031; G02B 13/12; G02B 2027/0178; G02B 27/30

(57) ABSTRACT

An optical system includes a first optical system to transmit image light emitted from an image display element that displays an image to form an intermediate image of the image light; an optical component having a partially reflective surface having functions of transmitting and reflecting the image light; a second optical system to reflect, to the optical component, the image light transmitted through the first optical system and transmitted through or reflected by the partially reflective surface of the optical component: and a light guide member to guide the image light reflected by the second optical system and transmitted through or reflected by the partially reflective surface of the optical component.

### CROSS-REFERENCE TO RELATED APPLICATIONS

This patent application is based on and claims priority pursuant to 35 U.S.C. § 119 (a) to Japanese Patent Application No. 2023-146631, filed on Sep. 11, 2023, in the Japan Patent Office, the entire disclosure of which is hereby incorporated by reference herein.

### BACKGROUND

### Technical Field

The present disclosure relates to an optical system and a display device.

### Related Art

In recent years, head-mounted displays (HMDs) have become increasingly popular as display devices. Smaller, transparent HMDs that resemble glasses are being developed. Additionally, technologies that miniaturize these devices by placing image display elements near the lenses of the glasses are well-known. Smart glasses and other glass devices, which overlay virtual images onto real-world scenes for the observer, as well as HMDs, are also widely recognized.

### SUMMARY

An embodiment of the present disclosure provides an optical system includes a first optical system to transmit image light emitted from an image display element that displays an image to form an intermediate image of the image light; an optical component having a partially reflective surface having functions of transmitting and reflecting the image light; a second optical system to reflect, to the optical component, the image light transmitted through the first optical system and transmitted through or reflected by the partially reflective surface of the optical component: and a light guide member to guide the image light reflected by the second optical system and transmitted through or reflected by the partially reflective surface of the optical component.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram of a head-mounted display as an example of a virtual image display device;

FIG. 2 is a cross-sectional view of an optical system for a virtual image display device according to Numerical Example 1;

FIGS. 3A and 3B are aberration diagrams of the optical system for the virtual image display device in FIG. 2;

FIG. 4 is a diagram illustrating the positions calculated from the aberration diagrams in FIGS. 3A and 3B;

FIG. 5 is a cross-sectional view of an optical system for a virtual image display device according to Numerical Example 2;

FIG. 6 is a cross-sectional view of an optical system for a virtual image display device according to Numerical Example 3;

FIGS. 7A and 7B are aberration diagrams of the optical system for a virtual image display device in FIG. 6; and

FIG. 8 is a cross-sectional view of an optical system for a virtual image display device according to Numerical Example 4.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image display optical system including a substrate, an input mirror, and a deflector is known. The substrate is placed in front of the observing eye and is transparent to visible light. The input mirror deflects a light beam for displaying images and causes it to propagate toward the observing eye while causing the light beam to be internally reflected alternately by the surface of the substrate facing the observing eye and the surface facing the external world. The deflector is placed immediately in front of the observing eye within the substrate. The deflector deflects the light beam propagated through the substrate, directing it to the observing eye. The entire surface of the substrate facing the external world is closely provided with an attenuator. At least a layer of the attenuator closest to the substrate is made of an optical multilayer film that reflects the light beam propagating through the substrate with a reflectance of substantially 100% and attenuates a light beam incident from the external world at an incident angle of approximately 0° with a predetermined attenuation rate.

However, this image displaying optical system still faces challenges in preventing light for displaying images (i.e., image light) from leaking outside the image display apparatus, such as preventing the light beam for displaying images from leaking outside the substrate or the optical system itself.

According to one aspect of the present disclosure, an optical system or a display device that prevents image light of an image display element from leaking outside can be provided.

An optical system for a virtual image display device according to an embodiment, a virtual image display device, and a head-mounted display are described below with reference to the drawings. In the drawings, like reference signs denote like elements, and overlapping description may be simplified or omitted as appropriate. In the present disclosure, the “optical system for virtual image display device” may be read as an “optical system”, and the “virtual image display device” and the “head-mounted display” may be read as a “display device”.

### Configuration of Head-Mounted Display

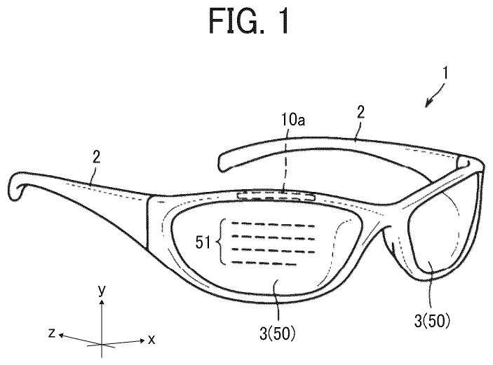

FIG. 1 is a diagram of a head-mounted display 1 as an example of a virtual image display device according to the present embodiment. In other words, the head-mounted display 1 is a type of virtual image display device that can be worn on the user's head. In the present embodiment, a head-mounted display 1 is, for example, smart glasses as an example of a glasses-type wearable terminal. The smart glasses may be referred to as a glass device or a glass display.

Examples of the head-mounted display 1 include virtual reality (VR) glasses, augmented reality (AR) Glasses, mixed reality (MR) Glasses, and extended reality (XR) glasses, which are all wearable terminals.

In FIG. 1, the head-mounted display 1 is a binocular head-mounted display. A head-mounted display 1 according to another embodiment of the present disclosure may be a monocular head-mounted display corresponding to one of the left and right eyes.

As illustrated in FIG. 1, the head-mounted display 1 includes a frame portion 2 and a lens portion 3. The lens portion 3 is fitted into the frame portion 2. A pair of lens portions 3 is disposed corresponding to the left and right eyes of the wearer.

In the head-mounted display 1, an image display element 10 for displaying an image is built in the frame portion 2. In FIG. 1, the image display element 10 is embedded in a portion of the frame portion 2 covering the upper edge of the lens portion 3. The installation position of the image display element 10 is not limited to the position illustrated in FIG. 1. Alternatively, the image display element 10 may be embedded in a portion of the frame portion 2 covering the lower edge or right-side edge of the lens portion 3. The image display element 10 may include a control board that controls the driving of the image display element 10. In this case, the control board may be embedded in a temple portion (a portion to be put on the ear of the wearer) of the frame portion 2 instead of the portion 10a in FIG. 1.

The image display element 10 displays an image to be recognized as a virtual image. Examples of the image display element 10 include an organic light emitting diode (OLED) array, a laser diode (LD) array, a light emitting diode (LED) array, micro electro-mechanical systems (MEMS), and a digital micromirror device (DMD).

In the following description, a z-direction in FIG. 1 is referred to as a first horizontal direction from the lens portion 3 to the eyes of the wearer (or a user), an x-direction in FIG. 1 is referred to as a second horizontal direction orthogonal to the z-direction, and a y-direction in FIG. 1 is referred to as a vertical direction orthogonal to each of the x-direction and the z-direction. The x-direction, the y-direction, and the z-direction orthogonal to each other form a left-handed system.

The term “direction” is used for convenience to describe the relative position between the components, and does not indicate an absolute direction. Depending on the posture of the user wearing the head-mounted display 1, for example, the z-direction may not be the horizontal direction and may be the vertical direction.

Light rays (i.e., image light that forms a virtual image) emitted from the respective pixels of the image display element 10 are emitted from the image display element 10 in the −y-direction to enter the lens portion 3 and proceed through the lens portion 3. Thereafter, the light rays are emitted from the lens portion 3 in the +z-direction (i.e., to the eyes of the wearer) for the display of a virtual image. In other words, the left and right lens portions 3 as a pair each form an eye box in a region encompassing the corresponding eye.

### Typical Head Mounted Display

For example, typical head-mounted displays fail to address light leakage from the image display element that displays images to the outside. For example, in typical augmented reality (AR) display devices, an optical system called Bird Bath and an optical system using a diffractive optical device as a light guide member are known. However, both of these optical systems face challenges with light leaking in the direction opposite to the direction in which the user views the images.

### Technical Idea Of Optical System And Display Device

According to one aspect of the present disclosure, an optical system or a display device that prevents image light of an image display element from leaking outside can be provided. Specifically, the optical system forms an intermediate image of image light from an image display element that displays images. For example, a first optical system forms an intermediate image of image light while transmitting the image light, whereas a second optical system collimates the intermediate image formed by the first optical system (i.e., makes it parallel light).

The optical system and the display device of the present disclosure includes a first optical system, a second optical system, an optical component, and a light guide member. The optical component is placed between the first optical system and the second optical system, and is located in front of the light guide member. The optical component includes a partially reflective surface that serves to both transmit and reflect image light. Image light from an image display element that displays an image enters the first optical system, transmitting through or reflecting off the partially reflective surface of the optical component. The image light then enters the second optical system, again transmitting through or reflecting off the partially reflective surface of the optical component. The image light finally enters the light guide member and is directed toward the user's eye.

More specifically, the first optical system transmits image light from the image display element that displays an image and forms an intermediate image of the image light. The optical component includes a partially reflective surface that serves to both transmit and reflect image light. The second optical system collimates and reflects the image light that has passed through the first optical system and has been transmitted through or reflected by the partially reflective surface of the optical member, to the optical component. The light guide member guides the image light reflected off the second optical system and reflected off or transmitted through the partially reflective surface of the optical component.

In the present disclosure, “transmit/transmitted through or reflect/reflected off” the partially reflective surface of the optical component may be read as “one of transmission and reflection”, and “reflect/reflected off or transmit/transmitted through” the partially reflective surface of the optical component may be read as “the other of transmission and reflection”. In other words, when the image light, which is guided from the first optical system to the second optical system, passes through the partially reflective surface of the optical component, the image light guided from the second optical system then reflects off the partially reflective surface of the optical component. Further, when the image light, which is guided from the first optical system to the second optical system, reflects off the partially reflective surface of the optical component, the image light guided from the second optical system then passes through the partially reflective surface of the optical component.

In the present disclosure, the reflection of image light does not necessarily mean total reflection of the image light. For example, it may involve reflecting a part (i.e., a large part) of the image light while transmitting the other part (i.e., a small part) of the image light. In addition, the transmission of the image light does not necessarily mean the total transmission of the image light. For example, it may involve transmitting a part (i.e., a large part) of the image light while reflecting the other part (i.e., a small part) of the image light.

The optical component and the light guide member may be separate members, or separate members may be combined into a single integral unit using, for example, adhesion. Alternatively, the optical component and the light guide member may be formed as a single integral unit.

According to one aspect of the present disclosure, the optical system and the display device each include an optical component with a partially reflective surface placed between a first optical system and a second optical system and located in front of a light guide member. The partially reflective surface of the optical component transmits or reflects the image light, directing it to the light guide member. This allows the image light to travel to the user's eye without moving back and forth in the longitudinal direction of the light guide member. This prevents the leakage of the image light to the outside. In other words, the route (or the optical path) of the image light is defined as passing through the first optical system, an optical component, the second optical system, the optical component, and finally the light guide member. This route allows the image light to travel to the user's eye without moving back and forth in the longitudinal direction of the light guide member, thus preventing the leakage of the image light to the outside.

The light guide member has a partial reflection surface that guides the image light in the longitudinal direction of the light guide member and reflects a part (e.g., most part or almost all) of the image light to the outside in the transverse direction (i.e., a direction orthogonal to the longitudinal direction) of the light guide member, directing it to the user's eye. In this case, a part (e.g., most part or almost all) of the image light reflects off the partially reflective surface of the light guide member to the outside and does not move back and forth in the longitudinal direction of the light guide member. This prevents unwanted light that does not reach the user's eye from traveling in the opposite direction of that to the user's eye and thus prevents the leakages of the image light to the outside.

For example, in the technology in which the image light moves back and forth in the longitudinal direction of the light guide member, the optical components are arranged in a linear sequence within their optical system. In this arrangement, the image light from the image display element enters a first optical system, passes through a polarizing plate, enters a light guide member, passes through a partially reflective surface, passes through a quarter-wave plate, enters a second optical system, passes through the quarter-wave plate again, re-enters the light guide member, and reflects off the partially reflective surface, finally reaching the user's eye. In this case, the polarization direction of light passing through the polarizing plate is designed to substantially coincide with the polarization direction in which the reflectance of the partially reflective surface is lower. This configuration allows more light to pass through the partially reflective surface and reach the user's eye. However, light in the polarization direction in which the reflectance of the partially reflective surface is lower might leak to the outside.

In the optical system and the display device according to an embodiment of the present disclosure, image light from an image display element that displays an image enters the first optical system, transmitting through or reflecting off the partially reflective surface of the optical component. The image light then enters the second optical system, again transmitting through or reflecting off the partially reflective surface of the optical component. The image light finally enters the light guide member and is directed from the partially reflective surface of the light guide member toward the user's eye. The optical component including the partially reflective surface is placed between the first optical system and the second optical system and located in front of the light guide member. As such, the first optical system, the second optical system, and the optical component operates in cooperation with each other to form an intermediate image. This arrangement allows the exit pupil to be located at a position that is sufficient to achieve its intended performance. This achieves a compact optical system while maintaining the eye box. In particular, the optical component is placed between the first optical system and the second optical system, and the partially reflective surface of the optical component is used to efficiently guide the image light to the light guide member. In other words, the optical path is defined as a folded structure in which light passes through the first optical system, the optical component, the second optical system, the optical component again, and then the light guide member. This structure allows for a shorter total length of the optical system and thus achieves a compact optical system and a miniaturized display device.

Theoretically, it is also possible to separately place a first optical member corresponding to the first optical system and a second optical member corresponding to the second optical system. In this configuration, the image light can enter the first optical system, then enter the first optical member, pass through its partially reflective surface, enter the second optical system, enter the second optical member, reflect off its partially reflective surface, enter the light guide member, reflect off its partially reflective surface, and finally reach the user's eye. However, in this case, the first optical system, the first optical member, the second optical system, and the second optical member are arranged in a linear sequency (or in a straight line). Thus, the total length of the optical system is excessively increased, and the increase in size of the optical system and the display device is inevitable.

In the optical system and the display device according to an embodiment of the present disclosure, the transmission and reflection characteristics of the partially reflective surface of the optical component and the light guide member are preferably the same. The partially reflective surfaces are placed on the optical component and the light guide member, respectively. By matching the characteristics of these partially reflective surfaces, the utilization efficiency of the image light can be increased. This effects are extremely effective in the following cases, as demonstrated in Numerical Examples 1 and 3 described below: the image light that has passed through the first optical system is reflected from the second optical system to the optical component after passing through the partially reflective surface of the optical component. The image light then reflects off the partially reflective surface of the optical component and is directed to the light guide member. In other words, the partially reflective surface of the optical component first transmits the image light and then reflects it later to enhance the utilization efficiency of the image light.

For example, when polarized light is considered as P-polarized light and S-polarized light, preferably, the partially reflective surfaces of both the optical component and the light guide member have either a higher reflectance for P-polarized light than for S-polarized light, or a higher reflectance for S-polarized light than for P-polarized light. This enables the see-through properties of the partially reflective surfaces of both the optical component and the light guide member, while enhancing the utilization efficiency of the image light. This effects are extremely effective in the following cases, as demonstrated in Numerical Examples 1 and 3 described below: the image light that has passed through the first optical system is reflected from the second optical system to the optical component after passing through the partially reflective surface of the optical component. The image light then reflects off the partially reflective surface of the optical component and is directed to the light guide member. In other words, the partially reflective surface of the optical component first transmits the image light and then reflects it later to enhance the utilization efficiency of the image light.

By roughening one end portion of the light guide member in its longitudinal direction (or the end opposite the incident portion of the image light in the longitudinal direction) and/or applying light-blocking treatment such as black coating, the effect of preventing unnecessary light that does not reach the user's eyes from traveling in the direction opposite to the user's eye and also from leaking outside is further enhanced. In this configuration, for example, even if a small amount of image light passes through the partially reflective surface of the light guide member, the image light is absorbed by the light-blocking portion, such as the rough surface and/or the black coating at one end portion in the longitudinal direction of the light guide member, and does not reciprocate in the longitudinal direction. This more effectively prevents the image light from leaking to the outside.

Preferably, multiple partially reflective surfaces are placed in the longitudinal direction of the light guide member. Multiple partially reflective surfaces are arranged on the light guide member in front of the user's eye. This enables a wide eye box and a wide angle of view while achieving a thin light guide member.

Preferably, a quarter-wave plate is placed between the optical component and the second optical system and switches the polarization of image light before and after it reflects off the second optical system to the optical component. For example, it is assumed that the partially reflective surface of the optical component has reflectance characteristics that the reflectance of S-polarized light is high and the reflectance of P-polarized light is low. Without a quarter-wave plate, when P-polarized image light enters the optical component, a greater amount of it passes through the partially reflective surface. The image light returning from the second optical system also passes through the partially reflective surface to a greater extent. With a quarter-wave plate, however, when P-polarized image light enters the optical component, a greater amount of it passes through the partially reflective surface of the optical component. Since the image light returning from the second optical system is switched to S-polarized light image light, a greater amount of the image light reflects off the partially reflective surface and is guided to the light guide member. As a result, the utilization efficiency of image light can be enhanced. When the partially reflective surface of the optical component has high reflectance for P-polarized light and low reflectance for S-polarized light, the same effects can be achieved when S-polarized image light enters the optical component. The optical system and the display device according to the present embodiment preferably satisfy the following conditional expressions (1) and (2).

$$50 \% < Rs \leq 100 \% \qquad ( 1 )$$

$$0 \% \leq Rp < 30 \% \qquad ( 2 )$$

In the above conditional expressions, Rs indicates a reflectance of S-polarized light at the partially reflective surface of the optical component when the S-polarized light is incident on the partially reflective surface of the optical component at an angle of 45 degrees, and Rp indicates a reflectance of P-polarized light at the partially reflective surface of the optical component when the P-polarized light is incident on the partially reflective surface of the optical component at an angle of 45 degrees.

Satisfying the conditional expressions (1) and (2) allows the image light to be effectively guided to the light guide member using the partially reflective surface of the optical component. In other words, the optical path, based on the folded structure where light travels from the first optical system, to the optical component, then to the second optical system, back to the optical component, and finally to the light guide member, minimizes the loss of the image light.

The utilization efficiency of light obtained when the quarter-wave plate is placed between the optical component and the second optical system is described in detail. It is assumed that the reflectance of S-polarized light is 90% at the partially reflective surface of the optical component when the S-polarized light is incident on the partially reflective surface of the optical component at an angle of 45 degrees, and the reflectance of P-polarized light is 10% at the partially reflective surface when the P-polarized light is incident on the partially reflective surface of the optical component at an angle of 45 degrees. Assuming there is no absorption of light at the partially reflective surface of the optical component, the transmittance of P-polarized light incident at the angle of 45 degrees is 90%. After passing through the quarter-wave plate twice, the reflectance of the light at the partially reflective surface is 90%, resulting in 81% of the light being incident on the light guide member. The transmittance of S-polarized light incident at the angle of 45 degrees is 10%. After passing through the quarter-wave plate twice, the reflectance of the light at the partially reflective surface is 10%, resulting in 1% of the light being incident on the light guide member.

In Numerical Examples 2 and 4, the image light that has passed through the first optical system is reflected from the second optical system to the optical component after passing through the partially reflective surface of the optical component. The image light then passes through the partially reflective surface of the optical component and is directed to the light guide member. In other words, the partially reflective surface of the optical component first reflects the image light and then transmits it later. In this case, by further placing a half-wave plate which is positioned between the optical component and the light guide member to switch the polarization of the image light guided from the optical component to the light guide member, the utilization efficiency of the image light is enhanced.

At least one of the first optical system and the second optical system preferably includes an optical element having an anamorphic surface. This allows the exit pupil of the optical system to be appropriately arranged depending on the direction, and thus the optical system can be downsized. Additionally, in the optical system, placing the pupil of the YZ plane inside the optical component or light guide member can make the light guide member thinner.

The optical system and the display device according to the present embodiment preferably include multiple lenses in the first optical system and also satisfy the following conditional expressions (3) and (4).

$$40 < vd 1 < 100 \qquad ( 3 )$$

$$10 < vd 2 < 40 \qquad ( 4 )$$

In the above conditional expressions, vd1 indicates the Abbe number of one lens included in the first optical system, and vd2 indicates the Abbe number of another lens included in the first optical system.

Satisfying the conditional expressions (3) and (4) successfully corrects the axial chromatic aberration and lateral chromatic aberration and achieves higher image quality.

The optical component preferably has a rough surface at least on a part of the optical component. This effectively reduces ghosting and flare. The rough surface can be placed on various parts of the optical component, such as the following.

For example, as in Numerical Examples 1 and 3 described later, the image light passes through the first optical system and then through the partially reflective surface of the optical component. It then reflects off the second optical system back to the optical component. After that, it reflects off the partially reflective surface and is guided into the light guide member. In this process, the partially reflective surface functions in transmission first, then reflection. To more effectively prevent image light leakage, the rough surface of the optical component is positioned opposite to (parallel with) at least one end face in the longitudinal direction of the light guide member. Additionally, a light-blocking treatment, such as black coating, is applied to the rough surface.

Further, as in Numerical Examples 2 and 4 described later, the image light passes through the first optical system and then reflects off the partially reflective surface of the optical component. It then reflects off the second optical system back to the optical component. After that, it passes through the partially reflective surface and is guided into the light guide member. In this process, the partially reflective surface functions in reflection first, then transmission. To more effectively prevent image light leakage, the rough surface of the optical component is positioned on a surface parallel to the longitudinal direction of the light guide member, rather than opposite the end faces. This rough surface is placed where the component of the image light from the first optical system that passes through the partially reflective surface without being reflected can be absorbed. Additionally, a light-blocking treatment, such as black coating, should be applied to this rough surface.

The second optical system preferably has a reflecting surface that is an anamorphic surface. This enables compact second optical system, optical system, and display device.

### Numerical Example 1

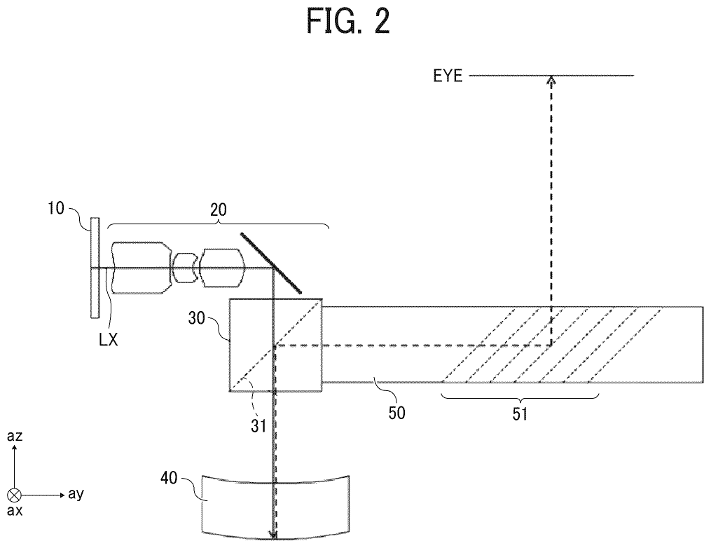

FIG. 2 is a cross-sectional view of an optical system 100 for a virtual image display device of Numerical Example 1. FIG. 2 illustrates a yz cross section of the image display element 10 and the optical system 100 for the virtual image display device. The yz cross section is a cross section including the optical axis LX. In FIG. 2, a three-dimensional space is defined by an ax-axis, an ay-axis, and an az-axis, which are orthogonal to each other. This three-dimensional space does not have to coincide with the three-dimensional space formed by the x-axis, the y-axis, and the z-axis depicted in FIG. 1. In other words, these three-dimensional spaces are defined as separate three-dimensional spaces.

In the present embodiment, the optical axis LX is defined as an optical path of light proceeding from the center of the effective pixel area of the image display element 10 in a direction perpendicular to the pixel array surface. The optical axis LX is also an optical axis of the optical system 100 for the virtual image display device, and is also an optical axis of each of the optical components (for example, the first optical system 20, the optical component 30, and the light guide member 50) included in the optical system 100 for the virtual image display device.

The optical system 100 for a virtual image display apparatus serves as a virtual image display apparatus or a head-mounted display by incorporating the image display element 10. The optical system 100 for the virtual image display device includes a first optical system 20, an optical component 30, a second optical system 40, and a light guide member 50. When the optical system 100 for the virtual image display device is mounted on the head-mounted display 1 of FIG. 1, the light guide member 50 serves as the lens portion 3. The first optical system 20, the optical component 30, and the second optical system 40 are embedded in a central portion (a portion to be put on the nose of the wearer) in the frame portion 2.

The image display element 10 emits image light in the +ay-axis direction (i.e., in the right direction in FIG. 2).

Image light, i.e., light containing information about image, from the image display element 10 passes through the first optical system 20. In FIG. 2, the first optical system 20 is composed of a negative lens, a positive lens, a positive lens, and a reflecting surface (or a mirror). The negative lens, the positive lens, and the positive lens of the first optical system 20 each are an aspheric lens with aspheric surfaces on both sides, or an optical element with an anamorphic surface (or an aspheric surface). In the first optical system 20, the negative lens, the positive lens, the positive lens, the stop, the negative lens, and the positive lens form an intermediate image while transmitting image light from the image display element 10 in the +ay-axis direction (or to the right in FIG. 2). The reflecting surface (or a mirror) then reflects or redirects the image light in the-az-axis direction (or downward in FIG. 2).

The optical component 30 includes a partially reflective surface 31 that serves to both transmit and reflect image light. The partially reflective surface 31 of the optical component 30 transmits the image light from the first optical system 20 (more specifically, the reflecting surface, or the mirror) in the-az-axis direction (or downward in FIG. 2).

The partially reflective surface 31 of the optical component 30 is implemented by, for example, a semi-reflective mirror, a polarizing Beam Splitter (PBS), or a coating.

The second optical system 40 receives the image light from the partially reflective surface 31 of the optical component 30 to collimate the intermediate image (or make it parallel) formed by the first optical system 20. Then, the second optical system 40 reflects the image light in the +az-axis direction (or upward in FIG. 2). The second optical system 40 is an optical element with an anamorphic surface (or an aspheric surface) that serves a reflecting surface. In FIG. 2, the image light before reflection by the second optical system 40 is depicted with solid lines, and the image light after reflection by the second optical system 40 is depicted with dashed lines.

The partially reflective surface 31 of the optical component 30 reflects the image light from the second optical system 40 in the +ay-axis direction (or to the right in FIG. 2), causing it to enter the light guide member 50.

The light guide member 50 is an optical component with a longitudinal direction along the ay-axis, the and a transverse direction along the az-axis and the ax-axis orthogonal to the ay-axis. The light guide member 50 has a partially reflective surface 51 that guides the image light in the longitudinal direction of the light guide member 50 and reflects a portion (e.g., most or almost all) of the image light in the +az-axis direction (or upward in FIG. 2). This directs the light to the outside in the transverse direction of the light guide member 50, toward the user's eye. Multiple partially reflective surfaces 51 are placed in the longitudinal direction of the light guide member 50 (or along the ay-axis). In FIG. 2, seven planar-shaped partially reflective surfaces 51 are arranged at prescribed intervals (for example, at intervals of 1.5 mm). The partially reflective surfaces 51 are placed to allow the image light to form a predetermined angle (e.g., an angle of 45 degrees) relative to the ay-axis.

The partially reflective surface 51 of the light guide member 50 is implemented by, for example, a semi-reflective mirror, a polarizing Beam Splitter (PBS), or a coating.

The transmission and reflection characteristics of the partially reflective surfaces 31 and 51 of the optical component 30 and the light guide member 50 are preferably the same. For example, preferably, the partially reflective surfaces 31 and 51 of both the optical component 30 and the light guide member 50 have either a higher reflectance for P-polarized light than for S-polarized light, or a higher reflectance for S-polarized light than for P-polarized light.

Image light from the image display element 10 enters the first optical system 20, reflects off the partially reflective surface 31 of the optical component 30, enters and then reflects off the second optical system 40, transmits through the partially reflective surface 31 of the optical component 30, enters the light guide member 50, and is directed from the partially reflective surface 51 of the light guide member 50 toward the user's eye.

The partially reflective surface 51 of the light guide member 50 may not be fully reflective surface (i.e., a small amount of image light may be transmitted through the partially reflective surface 51). Considering this situation, one end face of the light guide member 50 in its longitudinal direction (or the end face opposite the other end face where the image light is incident) and the area adjacent to the optical component 30 may be subjected to light-blocking treatment such as black coating.

Table 1 presents lens data of the optical system 100 for the virtual image display device of Numerical Example 1 (FIG. 1).

TABLE 1

| | Ry | Rx | D | Nd | νd | | |
|---|---|---|---|---|---|---|---|
| 0 | ∞ | ∞ | 0.000 | | | | |
| 1 | ∞ | ∞ | 0.540 | 1.51633 | 64.14 | | S-BSL7 (OHARA) |
| 2 | ∞ | ∞ | 0.968 | | | | |
| 3* | −3.527 | −7.941 | 3.623 | 1.53100 | 56 | | E48R (ZEON) |
| 4* | 7.104 | −3.782 | 0.200 | | | | |
| 5* | 1.473 | 3.580 | 1.307 | 1.63200 | 23 | | OKP4HT (Osaka |
| | | | | | | | Gas Chemicals) |
| 6* | 0.673 | 1.924 | 0.433 | | | | |
| 7* | 1.510 | 2.284 | 2.928 | 1.53100 | 56 | | E48R (ZEON) |
| 8* | −1.768 | −2.556 | 2.035 | | | | |
| 9 | ∞ | ∞ | −2.000 | | | REFLECTION | |
| 10 | ∞ | ∞ | −6.000 | 1.53100 | 56 | | E48R (ZEON) |
| 11 | ∞ | ∞ | −6.000 | | | | |
| 12* | 35.080 | 20.688 | −3.647 | 1.53100 | 56 | | E48R (ZEON) |
| 13* | 21.800 | 23.564 | 3.647 | 1.53100 | 56 | REFLECTION | |
| 14* | 35.080 | 20.688 | 6.000 | | | | E48R (ZEON) |
| 15 | ∞ | ∞ | 3.000 | 1.53100 | 56 | | |
| 16 | ∞ | ∞ | −3.000 | 1.53100 | 56 | REFLECTION | E48R (ZEON) |
| 17 | ∞ | ∞ | A | 1.53100 | 56 | | E48R (ZEON) |
| 18 | ∞ | ∞ | 2.500 | 1.53100 | 56 | REFLECTION | E48R (ZEON) |
| 19 | ∞ | ∞ | 15.000 | | | | |

In Table 1, Ry is a radius of curvature (or a paraxial radius of curvature) (mm) of each surface of the optical elements in the y-direction (i.e., the y-axis orthogonal to the optical axis LX), and Rx is a radius of curvature (or a paraxial radius of curvature) (mm) of each surface of the optical elements in the x-direction (the x-axis orthogonal to the optical axis LX). Further, D is the thickness of each optical element on the optical axis LX or the distance between the optical elements on the optical axis LX, Nd is a refractive index for the d-line (a wavelength of 587.562 nm), and vd is an Abbe number of the d-line. The right column of the Abbe number in Table 1 presents the product name and manufacturer of the material of the optical element.

The numbers in Table 1 are assigned to the respective surfaces of the virtual image display device (or a head-mounted display) in order from the image display element 10. Number 0 in the Table indicates an image display surface (i.e., pixel array surface) of the image display element 10. In Table, No. 1 and No. 2 indicate the respective surfaces of the cover glass included in the image display element 10. The cover glass is a glass plate that covers the image display surface of the image display element 10.

Numbers 3 to 19 in Table 1 indicate the first optical system 20, the optical component 30, the second optical system 40, and the light guide member 50 (an optical system 100 for a virtual image display device, optical system).

The mark A in the column of the interval D for No. 17 in Table 1 indicates the distance in the optical-axis LX direction between the multiple partially reflective surfaces 51 of the light guide member 50. For convenience, this is referred to as interval A. The intervals A are −19, −17.5, −16, −14.5, −13, −11.5, and −10 mm in order from the nearest partially reflective surface, which is closest to the partially reflective surface 31 of the optical component 30. In other words, the seven partially reflective surfaces 51 are disposed at equal intervals of 1.5 mm.

The angles of view of the virtual image in the vertical direction, the horizontal direction, and the diagonal direction are 20.3 degrees, 30.9 degrees, and 35.8 degrees, respectively. The distance to the virtual image is infinite.

In Table 1, the surfaces marked with “*” represent aspherical surfaces. More specifically, these aspherical surfaces are anamorphic aspherical surfaces having an anamorphic power. Table 2 is a list of data of each aspherical surface.

TABLE 2
Conic constant

| | Ky | Kx |
|---|---|---|
| 3 | 0.000 | 0.000 |
| 4 | 0.000 | 0.000 |
| 5 | 0.000 | 0.000 |
| 6 | 0.000 | 0.000 |
| 7 | 0.000 | 0.000 |
| 8 | 0.000 | 0.000 |
| 12, 13 | 0.000 | 0.000 |
| 14 | 0.000 | 0.000 |

Coefficient of rotational symmetry

| | AR₄ | AR₆ | AR₈ | AR₁₀ |
|---|---|---|---|---|
| 3 | 1.00880E−05 | 3.13268E−03 | −1.46089E−04 | 6.89388E−06 |
| 4 | −8.08688E−03 | −6.58111E−04 | 2.56529E−03 | 8.45032E−07 |
| 5 | 3.35105E−10 | −1.95545E−02 | 2.07763E−02 | −6.14881E−03 |
| 6 | −1.21976E−01 | −2.52017E−07 | 8.85368E−02 | −7.61448E−01 |
| 7 | −2.04256E−02 | 3.36722E−04 | −7.40448E−05 | −3.62963E−06 |
| 8 | 1.27274E−02 | 6.05470E−03 | −4.43482E−03 | 2.88908E−03 |
| 12, 13 | 1.24789E−04 | 3.69949E−08 | −8.66547E−11 | 2.74735E−12 |
| 14 | −1.42756E−06 | −9.10162E−09 | 7.16687E−11 | 8.45555E−12 |

Rotational asymmetry coefficient

| | AP₄ | AP₆ | AP₈ | AP₁₀ |
|---|---|---|---|---|
| 3 | −2.62004E+01 | 8.04145E−01 | 2.35168E−01 | −3.32289E−02 |
| 4 | 1.12167E+00 | 7.40352E−01 | 1.12057E+00 | −3.52109E−01 |
| 5 | 3.96972E+03 | 1.18791E+00 | 1.18433E+00 | 1.22335E+00 |
| 6 | 6.92306E−01 | 2.48479E+01 | 4.73608E−01 | 6.70531E−01 |
| 7 | 6.54473E−03 | −1.90883E+00 | 3.64809E+00 | 4.30195E+00 |
| 8 | −3.03428E−03 | 3.57028E−01 | 1.67773E−01 | 1.83561E−01 |
| 12, 13 | 7.33506E−01 | −8.05194E−01 | −4.43096E−01 | −2.58495E−01 |
| 14 | 2.41885E+00 | −2.36199E−01 | −1.90463E−01 | 1.38826E+00 |

In Table 2, the capital letter “E” represents a power in which 10 is the base and the number on the right of E is an exponent.

Further, the shape of the anamorphic aspherical surface satisfies the following equation where Cx is a paraxial radius of curvature (1/Rx) in the x-axis, Cy is a paraxial radius of curvature (1/Ry) in the y-axis, X (mm) is the height in the x-axis from the optical axis LX, Y (mm) is the height in the y-axis from the optical axis LX, Kx is the conic constant in the x-axis, Ky is the conic coefficient in the y-axis, AR₄, AR_{6,}. are even-numbered coefficients of rotational symmetry equal to or higher than the fourth order, and AP₄, AP₆, are even-numbered coefficients of rotational asymmetry equal to or higher than the fourth order.

$$Z = ( {CxX}^{2} + {CyY}^{2} ) / \{ 1 + √ ( 1 - ( 1 + Kx ) {Cx}^{2} {X}^{2} - ( 1 + Ky ) {Cy}^{2} {Y}^{2} ) \} + {{AR}_{4} ( ( 1 - {AP}_{4} ) {X}^{2} + ( 1 + {AP}_{4} ) {Y}^{2} )}^{2} + {{AR}_{6} ( ( 1 - {AP}_{6} ) {X}^{2} + ( 1 + {AP}_{6} ) {Y}^{2} )}^{3} + {{AR}_{8} ( ( 1 - {AP}_{8} ) {X}^{2} + ( 1 + {AP}_{8} ) {Y}^{2} )}^{4} + {AR}_{10} \cdot {( ( 1 - {AP}_{10} ) {X}^{2} + ( 1 + {AP}_{10} ) {Y}^{2} )}^{5}$$

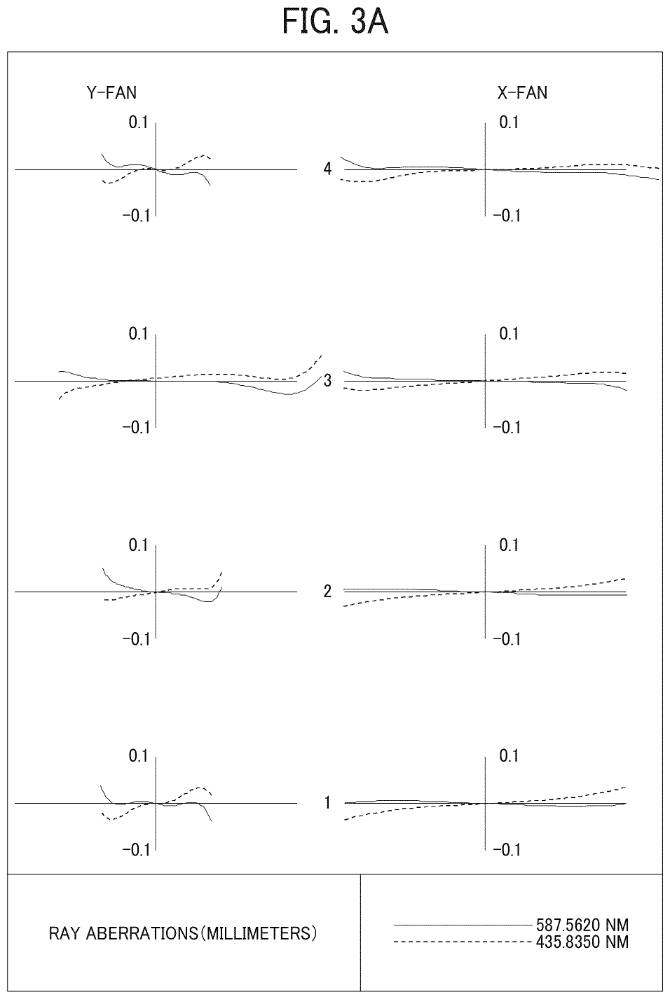

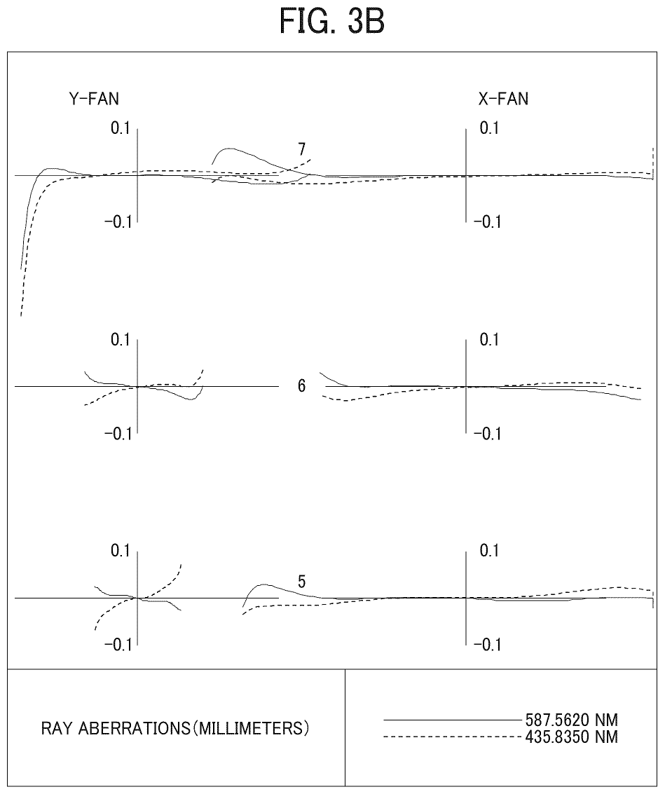

FIGS. 3A and 3B are aberration diagrams (lateral aberration diagrams) of the optical system 100 for a virtual image display device (or an optical system) of Numerical Example 1. In FIGS. 3A and 3B, the solid lines indicate the d-line, and the broken lines indicate the g-line. It can be seen from FIGS. 3A and 3B that the aberration (lateral aberration) in the optical system 100 for the virtual image display device of Numerical Example 1 is corrected at a high level (favorably), enabling excellent image quality.

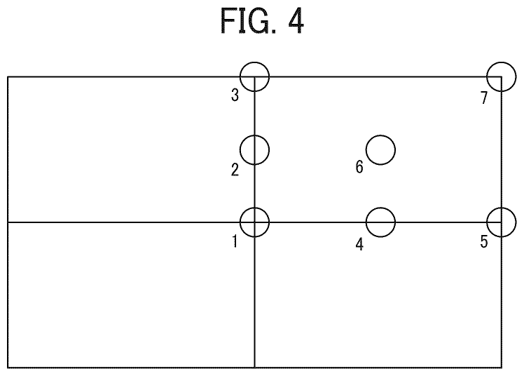

FIG. 4 is a diagram illustrating the positions calculated from the aberration diagrams in FIGS. 3A and 3B. The aberrations are calculated assuming that an image is formed by an ideal lens having a focal length of 17 mm. As illustrated in FIG. 4, the positions where the aberration (lateral aberration) is calculated are as follows.

1: Center 2: Object height at the halfway point between the center and the vertical end 3: Object height at the vertical end 4: Object height at the halfway point between the center and the horizontal end 5: Object height at the horizontal end 6: Object height at the halfway point between the center and the diagonal end 7: Object height at the diagonal end

### Numerical Example 2

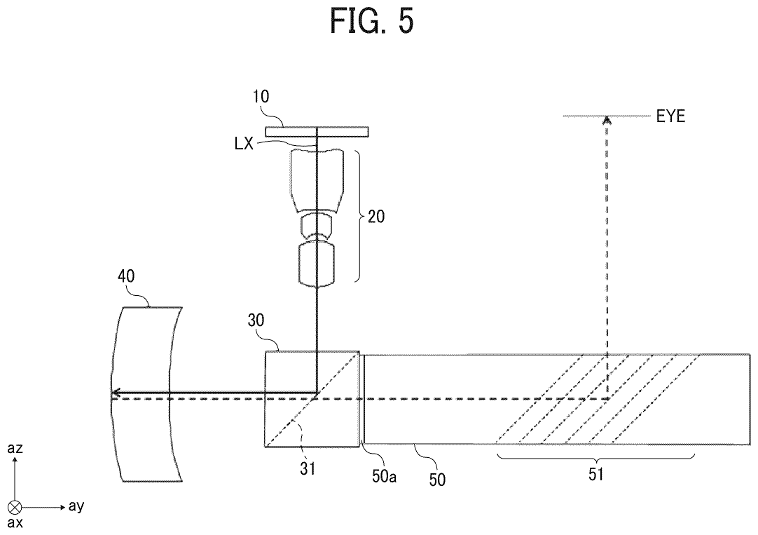

FIG. 5 is a cross-sectional view of an optical system 100 for a virtual image display device of Numerical Example 2.

The optical system 100 for the virtual image display device in Numerical Example 2 (FIG. 5) uses the same optical elements as the optical system in Numerical Example 1 (FIG. 2), but differs in the characteristics of the image light and/or the transmission and reflection characteristics of the partially reflective surface 31 of the optical component 30.

More specifically, the partially reflective surface 31 reflects the image light when directing it from the first optical system 20 to the second optical system 40; and transmits the image light when directing it from the second optical system 40 to the light guide member 50.

In Numerical Example 2 (FIG. 5) of the optical system 100 for the virtual image display device, image light from the image display element 10 enters the first optical system 20, reflects off the partially reflective surface 31 of the optical component 30, enters and then reflects off the second optical system 40, transmits through the partially reflective surface 31 of the optical component 30, enters the light guide member 50, and is directed from the partially reflective surface 51 of the light guide member 50 toward the user's eye. In FIG. 5, the image light before reflection by the second optical system 40 is depicted with solid lines, and the image light after reflection by the second optical system 40 is depicted with dashed lines.

In the optical system 100 for the virtual image display device of Numerical Example 2, it is preferable to place a half-wave plate 50a between the optical component 30 (with its partially reflective surface 31) and the light guide member 50 (with its partially reflective surface 51) to further increase the utilization efficiency of the image light.

As described above, the optical system 100 for a virtual image display device (or an optical system) of Numerical Example 2 (FIG. 5) uses the same optical elements as the optical system 100 for the virtual image display device (or the optical system) of Numerical Example 1 (FIG. 2). The lens shape, lens spacing, refractive indices, and Abe numbers have not been changed. As such, the lens data, the aspherical data, and the aberration diagram (lateral aberration diagram) are common.

### Numerical Example 3

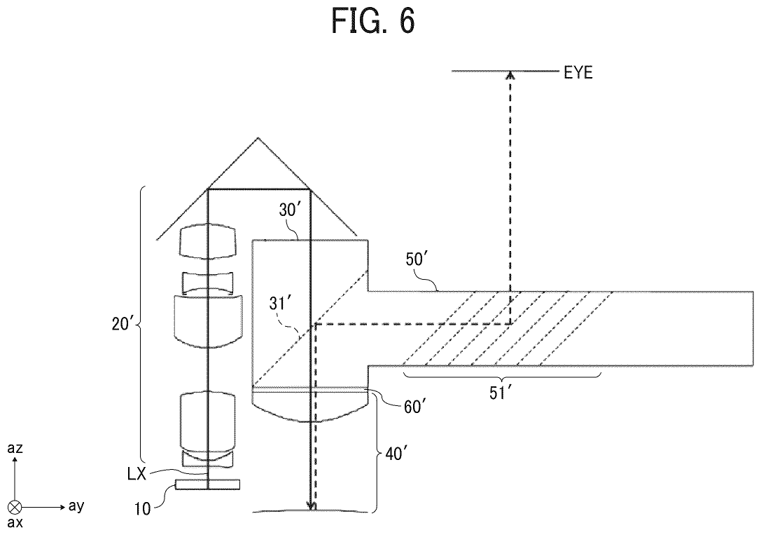

FIG. 6 is a cross-sectional view of an optical system 100 for a virtual image display device of Numerical Example 3.

The optical system 100 for the virtual image display device includes a first optical system 20′, an optical component 30′, a second optical system 40′, and a light guide member 50′. A quarter-wave plate 60′ is placed between the optical component 30′ and the second optical system 40′. The optical component 30′ and the light guide member 50′ are placed as an integrally molded product.

The image display element 10 emits image light in the +az-axis direction (i.e., upward in FIG. 6).

Image light, i.e., light containing information about an image, from the image display element 10 passes through the first optical system 20′. In FIG. 6, the first optical system 20′ is composed of a negative lens, a positive lens, another positive lens, a stop, another negative lens, and still another positive lens, and an umbrella-shaped double reflection surface (or mirror). Each lens included in the first optical system 20′ is an aspheric lens with aspheric surfaces on both sides, or an optical element with an anamorphic surface (or an aspheric surface). In the first optical system 20′, the negative lens, the positive lens, the positive lens, the stop, the negative lens, and the positive lens form an intermediate image while transmitting image light from the image display element 10 in the +az-axis direction (or upward in FIG. 6). The double reflection surface (or mirror) then reflects or redirects the image light in the +ay-axis direction (or to the right in FIG. 6), and subsequently reflects or redirects it in the-az-axis direction (or downward in FIG. 6).

The optical component 30′ includes a partially reflective surface 31′ that serves to both transmit and reflect image light. The partially reflective surface 31′ of the optical component 30′ transmits the image light from the first optical system 20′ (more specifically, the double reflection surface, or the mirror) in the-az-axis direction (or downward in FIG. 6).

The second optical system 40′ receives the image light from the partially reflective surface 31′ of the optical component 30′ to collimate the intermediate image (or make it parallel) formed by the first optical system 20′. Then, the second optical system 40′ reflects the image light in the +az-axis direction (or upward in FIG. 6). The second optical system 40′ is an optical element with an anamorphic surface (or an aspheric surface) that serves a reflecting surface. In FIG. 6, the image light before reflection by the second optical system 40′ is depicted with solid lines, and the image light after reflection by the second optical system 40′ is depicted with dashed lines.

The partially reflective surface 31′ of the optical component 30′ reflects the image light from the second optical system 40′ in the +ay-axis direction (or to the right in FIG. 6), causing it to enter the light guide member 50′.

The quarter-wave plate 60′ placed between the optical component 30′ and the second optical system 40′ switches the polarization of the image light before and after reflection from the second optical system 40′ to the optical component 30′. The image light refers to image light indicated by the solid line and image light indicated by the dashed line. For example, the quarter-wave plate 60′ switches from P-polarized light to S-polarized light or from S-polarized light to P-polarized light.

The light guide member 50′ is a tunnel member with a longitudinal direction along the ay-axis, the and a transverse direction along the az-axis and the ax-axis orthogonal to the ay-axis. The light guide member 50′ has a partially reflective surface 51′ that guides the image light in the longitudinal direction of the light guide member 50′ and reflects a portion (e.g., most or almost all) of the image light in the +az-axis direction (or upward in FIG. 6). This directs the light to the outside in the transverse direction of the light guide member 50′, toward the user's eye. Multiple partially reflective surfaces 51′ are placed in the longitudinal direction of the light guide member 50′ (or along the ay-axis). In FIG. 6, seven planar-shaped partially reflective surfaces 51′ are arranged at prescribed intervals (for example, at intervals of 1.5 mm). The partially reflective surfaces 51′ are placed to allow the image light to form a predetermined angle (e.g., an angle of 45 degrees) relative to the ay-axis.

In Numerical Example 3 (FIG. 6) of the optical system 100 for the virtual image display device, image light from the image display element 10 enters the first optical system 20′, reflects off the partially reflective surface 31′ of the optical component 30′, enters and then reflects off the second optical system 40′, transmits through the partially reflective surface 31′ of the optical component 30′, enters the light guide member 50′, and is directed from the partially reflective surface 51′ of the light guide member 50′ toward the user's eye.

Table 3 presents lens data of the optical system 100 for the virtual image display device of Numerical Example 3 (FIG. 6).

TABLE 3

| | Ry | Rx | D | Nd | νd | | |
|---|---|---|---|---|---|---|---|
| 0 | ∞ | ∞ | 0.000 | | | | |
| 1 | ∞ | ∞ | 0.700 | 1.51633 | 64.14 | | S-BSL7 |
| | | | | | | | (OHARA) |
| 2 | ∞ | ∞ | 0.907 | | | | |
| 3* | −49.987 | 42.228 | 0.386 | 1.63200 | 23 | | OKP4HT |
| | | | | | | | (Osaka Gas |
| | | | | | | | Chemicals) |
| 4* | 1.986 | 8.389 | 0.565 | | | | |
| 5* | 318.093 | 32.039 | 4.117 | 1.53100 | 56 | | E48R (ZEON) |
| 6* | −7.101 | −4.834 | 3.000 | | | | |
| 7* | 3.897 | 5.837 | 3.383 | 1.53100 | 56 | | E48R (ZEON) |
| 8* | 29.735 | −6.529 | 0.250 | | | | |
| 9 | STOP | | 0.450 | | | | |
| 10* | −4.283 | −73.448 | 0.900 | 1.63200 | 23 | | OKP4HT |
| | | | | | | | (Osaka Gas |
| | | | | | | | Chemicals) |
| 11* | 9.234 | 5.389 | 1.082 | | | | |
| 12* | 5.744 | 6.926 | 2.363 | 1.53100 | 56 | | E48R (ZEON) |
| 13* | −4.883 | −17.731 | 0.896 | | | | |
| 14 | ∞ | ∞ | 1.500 | | | | |
| 15 | ∞ | ∞ | −7.000 | | | REFLECTION | |
| 16 | ∞ | ∞ | 3.500 | | | REFLECTION | |
| 17 | ∞ | ∞ | 10.000 | 1.49200 | 57 | | PMMA |
| 18 | ∞ | ∞ | 0.350 | 1.58800 | 28 | | QUARTER- |
| | | | | | | | WAVE PLATE |
| 19 | ∞ | ∞ | 2.026 | 1.53100 | 56 | | E48R (ZEON) |
| 20* | −5.750 | 408.987 | 6.000 | | | | |
| 21* | 46.445 | −32.506 | −6.000 | | | REFLECTION | |
| 22* | −5.750 | 408.987 | −2.026 | 1.53100 | 56 | | E48R (ZEON) |
| 23 | ∞ | ∞ | −0.350 | 1.58800 | 28 | | QUARTER- |
| | | | | | | | WAVE PLATE |
| 24 | ∞ | ∞ | −4.000 | 1.49200 | 57 | | PMMA |
| 25 | ∞ | ∞ | A | 1.49200 | 57 | REFLECTION | PMMA |
| 26 | ∞ | ∞ | −2.500 | 1.49200 | 57 | REFLECTION | PMMA |
| 27 | ∞ | ∞ | −15.000 | | | | |

The numbers in Table 3 are assigned to the respective surfaces of the virtual image display device (or a head-mounted display) in order from the image display element 10. Number 0 in Table 3 indicates an image display surface (i.e., pixel array surface) of the image display element 10. Numbers 1 and 2 in Table 3 indicate the respective surfaces of the cover glass included in the image display element 10. The cover glass is a glass plate that covers the image display surface of the image display element 10.

Numbers 3 to 27 in Table 3 indicate the first optical system 20′, the optical component 30′, the second optical system 40′, the light guide member 50′, and the quarter-wave plate 60′ (an optical system 100 for a virtual image display device, optical system).

The mark A in the column of the interval D for No. 25 in Table 3 indicates the distance in the optical-axis LX direction between the multiple partially reflective surfaces 51′ of the light guide member 50′. For convenience, this is referred to as interval A. The intervals A are −18, −16.5, −15, −13.5, −12, −10.5, and −9 mm in order from the nearest partially reflective surface, which is closest to the partially reflective surface 31′ of the optical component 30′. In other words, the seven partially reflective surfaces 51′ are disposed at equal intervals of 1.5 mm.

In Table 3, the surfaces marked with “*” represent aspherical surfaces. More specifically, these aspherical surfaces are anamorphic aspherical surfaces having an anamorphic power. Table 4 presents data of the respective aspherical surfaces. The definition and description (reading method) of the aspheric data are the same as those described with reference to Table 2 in Numerical Example 1.

TABLE 4
Aspheric Coefficient
Conic constant

| | Ky | Kx |
|---|---|---|
| 3 | 0.000 | 10.000 |
| 4 | 0.000 | 0.000 |
| 5 | 0.000 | −1.000 |
| 6 | 0.000 | −1.966 |
| 7 | 0.000 | −0.814 |
| 8 | 8.755 | −4.320 |
| 10 | 0.000 | 0.000 |
| 11 | 0.000 | 0.000 |
| 12 | −6.616 | −0.180 |
| 13 | 0.000 | 0.000 |
| 20, 22 | −2.014 | 10.000 |
| 21 | 0.000 | 0.000 |

Coefficient of rotational symmetry

| | AR₄ | AR₆ | AR₈ | AR₁₀ |
|---|---|---|---|---|
| 3 | −1.43319E−02 | 5.49950E−04 | 1.83461E−09 | −4.39141E−15 |
| 4 | −1.21868E−02 | 1.29734E−07 | 5.41669E−06 | −1.37384E−06 |
| 5 | 1.02406E−02 | −1.33377E−04 | −1.16834E−04 | 1.42719E−05 |
| 6 | −9.30646E−04 | 1.98542E−05 | −5.86974E−06 | 1.36359E−07 |
| 7 | −1.70706E−04 | −7.91305E−07 | 2.63627E−12 | 8.24812E−08 |
| 8 | −4.90498E−04 | 1.00632E−04 | 9.87588E−09 | 2.64919E−07 |
| 10 | 3.50378E−05 | 2.34584E−06 | 5.82059E−06 | −1.62222E−07 |
| 11 | −8.64307E−07 | −3.54728E−05 | 2.76350E−06 | 3.56196E−11 |
| 12 | −9.19876E−06 | 1.62604E−07 | 4.08378E−08 | 6.38966E−10 |
| 13 | 6.42431E−04 | 7.91790E−06 | −1.96164E−07 | 1.27197E−07 |
| 20, 22 | 5.49568E−08 | 3.42543E−07 | 7.14100E−11 | −6.98795E−12 |
| 21 | −6.34106E−08 | −1.06969E−09 | 3.50266E−10 | −4.66720E−13 |

Rotational asymmetry coefficient

| | AP₄ | AP₆ | AP₈ | AP₁₀ |
|---|---|---|---|---|
| 3 | 4.25274E−01 | 1.60936E+00 | −2.95984E+00 | 5.88007E+01 |
| 4 | 6.85756E−01 | 1.27839E+01 | 1.15330E+00 | 1.89176E+00 |
| 5 | 8.12958E−01 | 1.46398E+00 | 8.04078E−01 | 9.23754E−01 |
| 6 | −5.80332E−01 | −3.16399E−01 | 1.82295E−01 | 1.35126E−01 |
| 7 | −1.06532E+00 | −1.52683E−01 | −1.44281E+01 | 1.59058E−01 |
| 8 | −1.56646E−01 | 3.50346E−01 | −1.42863E+00 | 1.30999E+00 |
| 10 | −2.33689E+00 | −1.03242E+00 | 1.34568E−01 | −4.33508E−03 |
| 11 | −4.78973E+00 | 1.87744E−01 | −3.40074E−02 | 5.94065E+00 |
| 12 | 2.65180E+00 | 5.17040E+00 | −1.12172E+00 | 2.99312E+00 |
| 13 | 1.06560E−01 | −7.44919E−01 | −3.66984E−01 | 1.13162E+00 |
| 20, 22 | 1.85344E+01 | 1.56478E+00 | −3.54290E−01 | 4.53189E−01 |
| 21 | −8.17879E+00 | −1.32091E+00 | 2.52377E−01 | 9.13467E−02 |

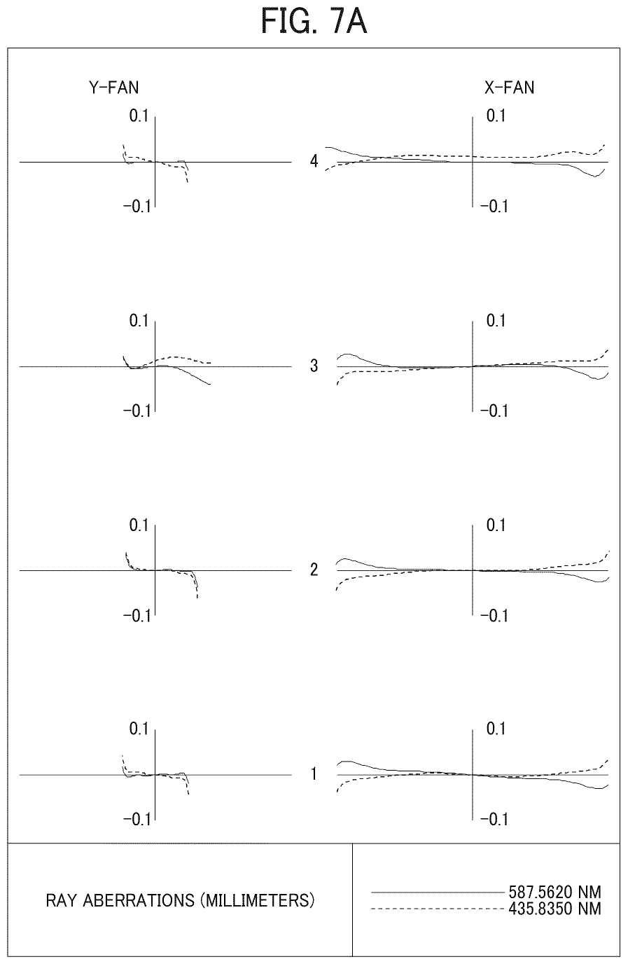

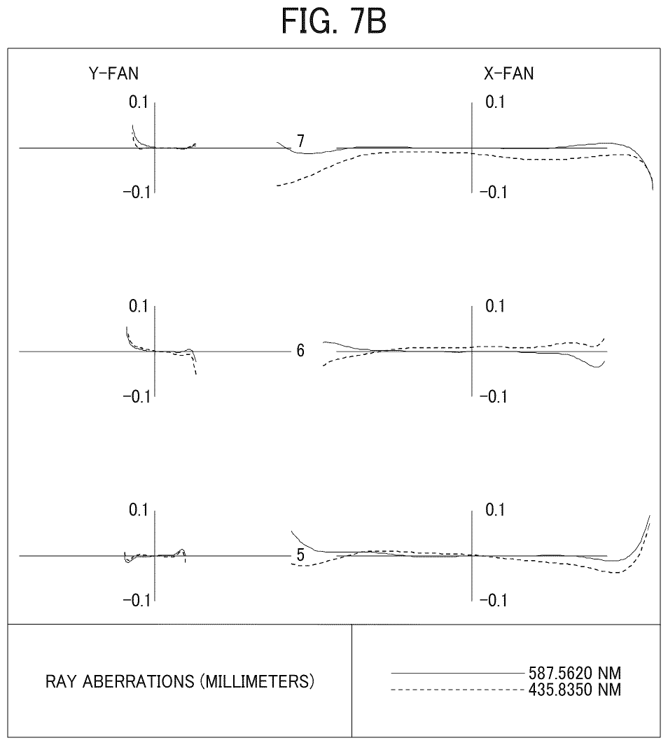

FIGS. 7A and 7B are aberration diagrams (lateral aberration diagrams) of the optical system 100 for a virtual image display device (or an optical system) of Numerical Example 3. In FIGS. 7A and 7B, a solid line indicates the d-line, and a broken line indicates the g-line. It can be seen from FIGS. 7A and 7B that the aberration (lateral aberration) in the optical system 100 for the virtual image display device of Numerical Example 3 is corrected at a high level (favorably), enabling excellent image quality. The positions at which the aberration diagrams (lateral aberration diagrams) of FIGS. 7A and 7B are calculated are the same as those described with reference to FIG. 4.

### Numerical Example 4

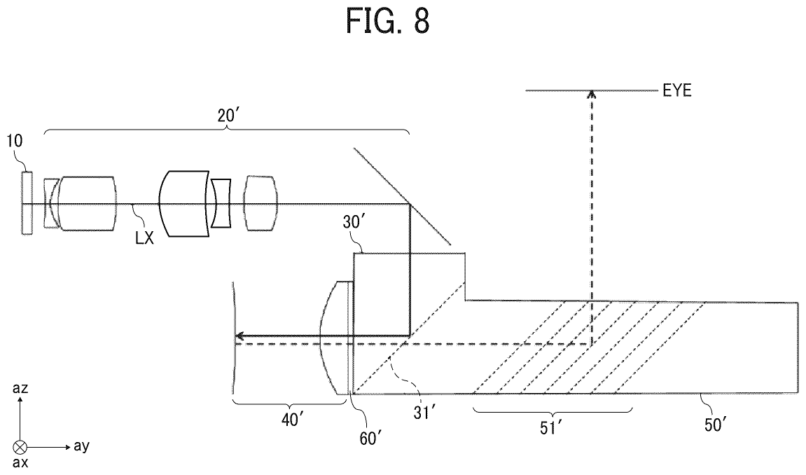

FIG. 8 is a cross-sectional view of an optical system 100 for a virtual image display device of Numerical Example 4.

The optical system 100 for the virtual image display device in Numerical Example 4 (FIG. 8) uses the same optical elements as the optical system in Numerical Example 3 (FIG. 6), but differs in the characteristics of the image light and/or the transmission and reflection characteristics of the partially reflective surface 31′ of the optical component 30′.

More specifically, the partially reflective surface 31′ reflects the image light when directing it from the first optical system 20′ to the second optical system 40′; and transmits the image light when directing it from the second optical system 40′ to the light guide member 50′.

In Numerical Example 4 (FIG. 8) of the optical system 100 for the virtual image display device, image light from the image display element 10 enters the first optical system 20′, reflects off the partially reflective surface 31′ of the optical component 30′, enters and then reflects off the second optical system 40′, transmits through the partially reflective surface 31′ of the optical component 30′, enters the light guide member 50′, and is directed from the partially reflective surface 51′ of the light guide member 50′ toward the user's eye. In FIG. 8, the image light before reflection by the second optical system 40′ is depicted with solid lines, and the image light after reflection by the second optical system 40′ is depicted with dashed lines.

In the optical system 100 for the virtual image display device of Numerical Example 4, it is preferable to place a half-wave plate between the optical component 30′ (with its partially reflective surface 31′) and the light guide member 50′ (with its partially reflective surface 51′) to further increase the utilization efficiency of the image light.

As described above, the optical system 100 for a virtual image display device (or an optical system) of Numerical Example 4 (FIG. 8) uses the same optical elements as the optical system 100 for the virtual image display device (or the optical system) of Numerical Example 3 (FIG. 6). The lens shape, lens spacing, refractive indices, and Abe numbers have not been changed. As such, the lens data, the aspherical data, and the aberration diagram (lateral aberration diagram) are common.

The above is a description of embodiments of the present disclosure. The embodiments of the present invention are not limited to those described above, and various modifications are possible within the scope of the technical idea of the present invention. For example, the embodiments of the present application also include contents obtained by appropriately combining the embodiments explicitly described in the specification or the obvious embodiments.

Aspects of the present disclosure are as follows.

### Aspect 1

An optical system includes a first optical system to transmit image light emitted from an image display element that displays an image to form an intermediate image of the image light; an optical component having a partially reflective surface having functions of transmitting and reflecting the image light; a second optical system to reflect, to the optical component, the image light transmitted through the first optical system and transmitted through or reflected by the partially reflective surface of the optical component: and a light guide member to guide the image light reflected by the second optical system and transmitted through or reflected by the partially reflective surface of the optical component.

### Aspect 2

In the optical system according to Aspect 1, the light guide member includes a partially reflective surface to reflect and emit a part of the image light outside the light guide member in a transverse direction of the light guide member, and the light guide member guides the image light in a longitudinal direction of the light guide member orthogonal to the transverse direction.

### Aspect 3

In the optical system according to Aspect 2, the partially reflective surface of the optical component has transmission and reflection characteristics same as transmission and reflection characteristics of the partially reflective surface of the light guide member.

### Aspect 4

In the optical system, according to Aspect 2, each of the partially reflective surfaces of the optical component and the partially reflective surface of the optical component has a reflectance for P-polarized light higher than for S-polarized light or has a reflectance for S-polarized light higher than P-polarized light. In other words, each of the partially reflective surface of the optical component and the partially reflective surface of the optical component has a reflectance (at an incident angle of 45 degrees) for S-polarized light that is higher than a reflectance (at an incident angle of 45 degrees) for P-polarized light.

### Aspect 5

In the optical system according to Aspect 3 or 4, the second optical system reflects, to the optical component, the image light transmitted through the first optical system and transmitted through the partially reflective surface of the optical component, and the light guide member guides the image light reflected by the second optical system and reflected by the partially reflective surface of the optical component.

### Aspect 6

In the optical system according to any one of Aspects 3 to 5, further including multiple partially reflective surfaces having the partially reflective surface, the multiple partially reflective surfaces arranged in the longitudinal direction of the light guide member.

### Aspect 7

The optical system according to any one of Aspects 1 to 6, further includes a quarter-wave plate between the optical component and the second optical system, the quarter-wave plate to switch polarization of the image light before and after reflection from the second optical system to the optical component.

### Aspect 8

In the optical system according to any one of Aspects 1 to 7, the optical system satisfies conditional expressions (1) and (2) below:

$$50 \% < R \leq 100 \% \qquad ( 1 )$$

$$0 \% \leq Rp < 30 \% \qquad ( 2 )$$

where
Rs indicates a reflectance of S-polarized light at the partially reflective surface of the optical component when the S-polarized light is incident on the partially reflective surface of the optical component at an angle of 45 degrees, and
Rp indicates a reflectance of P-polarized light at the partially reflective surface of the optical component when the P-polarized light is incident on the partially reflective surface of the optical component at an angle of 45 degrees.

### Aspect 9

The optical system according to any one of Aspects 1 to 8, further includes a half-wave plate between the optical component and the light guide member, the half-wave plate to switch polarization of the image light that is transmitted through the first optical system, reflected by the partially reflective surface of the optical component to the second optical system, reflected by the second optical system, and transmitted through the partially reflective surface of the optical component to the light guide member.

### Aspect 10

In the optical system according to any one of Aspects 1 to 9, at least one of the first optical system and the second optical system includes an optical element having an anamorphic surface.

### Aspect 11

In the optical system according to any one of Aspects 1 to 10,
wherein the first optical system includes multiple lenses, and
the optical system satisfies conditional expressions (3) and (4) below:

$$40 < vd 1 < 100 \qquad ( 3 )$$

$$10 < vd 2 < 40 \qquad ( 4 )$$

where
vd1 indicates Abbe number of one lens of the multiple lenses included in the first optical system, and
vd2 indicates Abbe number of another lens of the multiple lenses.

### Aspect 12

In the optical system according to any one of Aspects 1 to 11, the optical component has a rough surface at least on a part of the optical component.

### Aspect 13

In the optical system according to any one of Aspects 1 to 12, the second optical system has a reflecting surface that is an anamorphic surface.

### Aspect 14

A display device includes the optical system according to any one of Aspects 1 to 12; and the image display element to emit image light to the optical system.

### Aspect 15

The optical system according to Aspect 1, the second optical system reflects, to the optical component, the image light transmitted through the first optical system and reflected by the partially reflective surface of the optical component, and the light guide member guides the image light reflected by the second optical system and transmitted through the partially reflective surface of the optical component.

### Aspect 16

In the optical system according to Aspect 1, the second optical system collimates and reflects the image light to the optical component.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An optical system comprising:
a first optical system to transmit image light emitted from an image display element that displays an image to form an intermediate image of the image light;
an optical component having a partially reflective surface having functions of transmitting and reflecting the image light;
a second optical system to reflect, to the optical component, the image light transmitted through the first optical system and transmitted through or reflected by the partially reflective surface of the optical component: and
a light guide member to guide the image light reflected by the second optical system and transmitted through or reflected by the partially reflective surface of the optical component.

2. The optical system according to claim 1,
wherein the light guide member includes a partially reflective surface to reflect and emit a part of the image light outside the light guide member in a transverse direction of the light guide member, and
the light guide member guides the image light in a longitudinal direction of the light guide member orthogonal to the transverse direction.

3. The optical system according to claim 2,
wherein the partially reflective surface of the optical component has transmission and reflection characteristics same as transmission and reflection characteristics of the partially reflective surface of the light guide member.

4. The optical system according to claim 2,
wherein each of the partially reflective surface of the optical component and the partially reflective surface of the light guide member has a reflectance at an angle of 45 degrees for S-polarized light that is higher than a reflectance at an angel of 45 degrees for P-polarized light.

5. An optical system according to claim 1,
wherein the second optical system reflects, to the optical component, the image light transmitted through the first optical system and transmitted through the partially reflective surface of the optical component, and
the light guide member guides the image light reflected by the second optical system and reflected by the partially reflective surface of the optical component.

6. The optical system according to claim 2, further comprising multiple partially reflective surfaces having the partially reflective surface, the multiple partially reflective surfaces arranged in the longitudinal direction of the light guide member.

7. The optical system according to claim 1, further comprising a quarter-wave plate between the optical component and the second optical system, the quarter-wave plate to switch polarization of the image light before and after reflection from the second optical system to the optical component.

8. The optical system according to claim 1,
wherein the optical system satisfies conditional expressions (1) and (2) below:
$$50 \% < Rs \leq 100 \% \qquad ( 1 )$$
$$0 \% \leq Rp < 30 \% \qquad ( 2 )$$
where
Rs indicates a reflectance of S-polarized light at the partially reflective surface of the optical component when the S-polarized light is incident on the partially reflective surface of the optical component at an angle of 45 degrees, and
Rp indicates a reflectance of P-polarized light at the partially reflective surface of the optical component when the P-polarized light is incident on the partially reflective surface of the optical component at an angle of 45 degrees.

9. The optical system according to claim 1, further comprising a half-wave plate between the optical component and the light guide member,
the half-wave plate to switch polarization of the image light that is:
transmitted through the first optical system,
reflected by the partially reflective surface of the optical component to the second optical system,
reflected by the second optical system, and
transmitted through the partially reflective surface of the optical component to the light guide member.

10. The optical system according to claim 1,
wherein at least one of the first optical system and the second optical system includes an optical element having an anamorphic surface.

11. The optical system according to claim 1,
wherein the first optical system includes multiple lenses, and the optical system satisfies conditional expressions (3) and (4) below:
$$40 < vd 1 < 100 \qquad ( 3 )$$
$$10 < vd 2 < 40 \qquad ( 4 )$$
where
vd1 indicates Abbe number of one lens of the multiple lenses included in the first optical system, and
vd2 indicates Abbe number of another lens of the multiple lenses.

12. The optical system according to claim 1,
wherein the optical component has a rough surface at least on a part of the optical component.

13. The optical system according to claim 1,
wherein the second optical system has a reflecting surface that is an anamorphic surface.

14. A display device comprising:
the optical system according to claim 1; and
the image display element to emit image light to the optical system.

15. The optical system according to claim 1,
wherein the second optical system reflects, to the optical component, the image light transmitted through the first optical system and reflected by the partially reflective surface of the optical component, and
the light guide member guides the image light reflected by the second optical system and transmitted through the partially reflective surface of the optical component.

16. The optical system according to claim 1,
wherein the second optical system collimates and reflects the image light to the optical component.
